(19) United States
(12) Patent Application Publication
(10) Pub. No.: US 2005/0068902 A1
(43) Pub. Date: Mar. 31, 2005

(54) Scalable broadband wireless mesh access network

(76) Inventor: Kamlesh Rath, San Ramon, CA (US)

Correspondence Address: GLENN PATENT GROUP, 3475 EDISON WAY, SUITE L, MENLO PARK, CA, 94025, US

(21) Appl. No.: 10/616,882

(22) Filed: Jul. 9, 2003

(51) Int. Cl. H04L 12/28

(52) U.S. Cl. 370/256

(57) ABSTRACT

The invention comprises a mesh access network architecture that provides a combination of high data rates to a large number of users and >99% coverage to potential customers in a service area. The network design also provides scalable capacity that scales to more capacity/users with additional frequency carriers and coverage over a large area with additional base-stations. This is achieved using a combination of centralized mesh network control and intelligent interference management.

### BACKGROUND OF THE INVENTION

1. Technical Field

The invention relates to wireless networks. More particularly, the invention relates to the overall network architecture of a scalable broadband wireless mesh access network.

2. Description of the Prior Art

There are a number of issues concerning the design of a wireless network which do not arise in a wired system. Two known approaches to wireless networking are those of point-multipoint networking and mesh networking.

Point-Multipoint (P-MP)

P-MP systems are by far the most common network architecture used in broadband wireless Internet access. A base station is established in a location visible to a number of customers. A backhaul connection is established to the base station, via wireless or wireline, and customer premise equipment (CPE) is installed at each customer's location. It is usually necessary to use an outdoor antenna to achieve reasonable range and performance.

One major drawback of P-MP is that base stations have to be located where it is possible to site a base station. Such a location may not coincide with a target customer base. Base stations are also expensive, and the cost of backhaul services can be prohibitive.

Another major drawback to P-MP is that the cost of the CPE installations, i.e. the “truck roll,” becomes prohibitive in the aggregate as more and more customers are added to the system.

Yet another drawback to P-MP is that there are inevitably be dead zones where some potential customers do not have line of sight (LOS) to the base station, and therefore cannot receive service.

Mesh Networking

Mesh networking, generally, dispenses with the idea of a base station, with each CPE also being a relay node. The backhaul connection is connected to one or more relay nodes, and each additional customer adds an additional relay node to the network.

A mesh network for urban and sub-urban environments requires the network to support a large number of users at a low initial cost per user and be usable in an environment with high-rise buildings (4-20 floors) or low-height buildings (1-4 floors with trees in environment). Unfortunately, mesh networking, as currently implemented, does not scale well beyond perhaps five relay nodes. Latency, i.e. the amount of delay added at each node, is increasingly noticeable as more relaying is necessary to get packets from a customer to the backhaul connection. One solution to the latency issue is have multiple backhaul connections, but doing so somewhat defeats the cost-effectiveness of mesh networking.

It would be advantageous to provide a mesh access network that: (1) supports a large number of users, e.g. up to 1000 users per sector (2) at broadband data rates and (3) with low latency for voice/video applications. It would also be advantageous if such network provided (4) support for capacity and coverage limited deployment scenarios, and (5) had a high spectrum reuse factor, i.e. it should reduce the distance between simultaneous active links using same carrier to get more capacity from network. Finally, it would be advantageous if such network (6) provided scalable deployment, i.e. if it could be deployed using two carriers, and if one could add more carriers to increase overall capacity and number of users.

### SUMMARY OF THE INVENTION

The invention comprises a mesh access network architecture that provides a combination of high data rates to a large number of users and >99% coverage to potential customers in a service area. The network design also provides scalable capacity that scales to more capacity/users with additional frequency carriers and coverage over a large area with additional base-stations. This is achieved in the presently preferred embodiment of the invention by using a combination of centralized mesh network control and intelligent interference management.

### BRIEF DESCRIPTION OF THE DRAWINGS

FIG. 1 is a block schematic diagram showing a repeater antenna structure according to the invention;

FIG. 2 is a block schematic diagram showing a network design for a base-station having six sectors according to the invention;

FIG. 3 is a block schematic diagram showing a network design in which system capacity is increased according to the invention;

FIG. 4 is a block schematic diagram showing a typical sector having level-1, level-2, and level-3 repeaters and associated terminals, and also showing a link tree and potential interferers that must be taken into account for time-slot scheduling according to the invention;

FIG. 5 is a block schematic diagram showing a system for bandwidth allocation in a fixed wireless network according to the invention; and

FIG. 6 is a flow diagram showing an algorithm for bandwidth allocation in a fixed wireless network according to the invention.

### DETAILED DESCRIPTION OF THE INVENTION

The invention comprises a mesh access network architecture that provides a combination of high data rates to a large number of users and >99% coverage to potential customers in a service area. The network design also provides scalable capacity that scales to more capacity/users with additional frequency carriers and coverage over a large area with additional base-stations. This is achieved in the presently preferred embodiment of the invention by using a combination of centralized mesh network control and intelligent interference management.

Nodes and Antennas

There are typically four types of nodes in a mesh network:
1. Outdoor repeaters with roof-top antennas.
2. Indoor terminals with indoor window mounted antennas.
3. Outdoor terminals with roof-top antennas.
4. Base-station with high gain antennas.

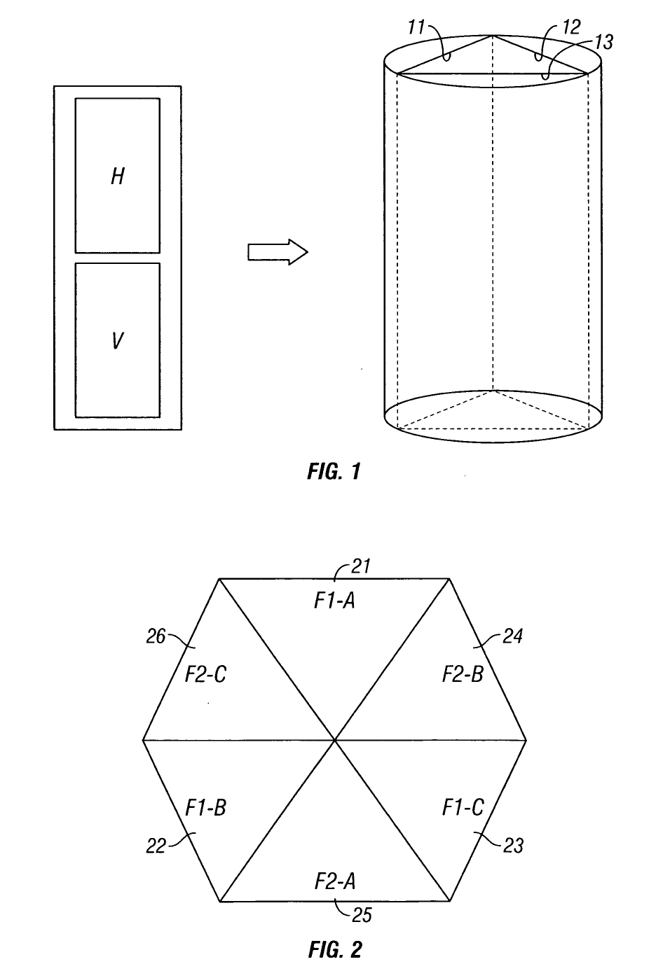

Outdoor repeaters according to the invention herein have roof-top antennas that have three antenna panels arranged within a cylindrical structure. FIG. 1 is a block schematic diagram showing a repeater antenna structure according to the invention. The three antenna panels 11, 12, 13 have a top-view of a triangle. The antenna panels can be constructed from off-the-shelf antennas. Each antenna panel has two antenna elements (H and V) that is mounted one on of top of the other for polarization diversity. Each antenna panel has an azimuth half-power beam width (HPBW) of 90 degrees. The repeater antenna is normally used as a switched beam antenna with one of the panels being activated at a time for directional transmission or reception to/from another node. It is also used sometimes in a near omni-directional mode with all panels activated to transmit/receive to/from all nearby nodes. The activation of each panel activates the H and V elements simultaneously using separate radio frequency (RF) units and baseband diversity module.

The indoor terminals with indoor antennas are window mounted to get the best possible signal from an indoor location. The indoor node also uses a split element antenna with H and V antenna elements that are combined using a power combiner. This provides some diversity combining gain without the higher cost of multiple RF units. The indoor antennas have a 90 degree azimuth HPBW.

The outdoor terminals have roof-top high gain antennas with small beam-widths. These antennas that have a similar structure as the indoor antenna, i.e. split element antenna with H and V antenna elements combined using a power combiner. The outdoor antennas have 18 degree azimuth and elevation HPBW.

The base-station sector antenna has a 20-30 degree azimuth HPBW. It has a similar structure as one of the panels on the repeater antenna. i.e. H and V elements mounted one on top of the other for polarization diversity. The activation of this panel activates the H and V elements simultaneously using separate RF units and baseband diversity module.

Wireless Links

The herein disclosed mesh access network consists of the following types of links:
1. Base-station to Repeater: This is a 2×2 diversity link in which diversity combining techniques are used in both directions of the link. The repeater switches to the proper antenna panel for transmit and receive. The repeater finds the direction (corresponding antenna face) of different subscriber units and switches to the appropriate antenna panel to send/receive packets to/from the subscriber.
2. Base-station to Indoor/Outdoor Terminal: This is a 2×1 diversity link in which diversity combining techniques are used at the base-station end.
3. Repeater to Repeater: This is a 2×2 diversity link in which diversity combining techniques are used in both directions of the link. Both repeaters switch to the proper antenna panels for transmit and receive. Each repeater learns the antenna face to use to communicate with its neighboring nodes by listening to the ISB pilot tone (as described in U.S. patent application Ser. No. 10/431,139 (COWA0001) also owned by the Applicant) from the neighbors. The repeater then switches on the appropriate antenna face when a node has a packet to send/receive to/from a neighbor.
4. Repeater to Indoor/Outdoor Terminal: This is a 2×1 diversity link in which diversity combining techniques are used at the Repeater end. The repeater uses the proper antenna panel to transmit/receive with a terminal.
   Network Design

Each base-station in the herein disclosed mesh access network preferably consists of six sectors, although those skilled in the art will appreciate that a different number of sectors may be used in connection with the invention herein. A sector consists of a large number of indoor terminal nodes, some outdoor terminal nodes, and a small number of outdoor repeaters. The nodes in each sector are arranged in a tree structure starting from the base-station.

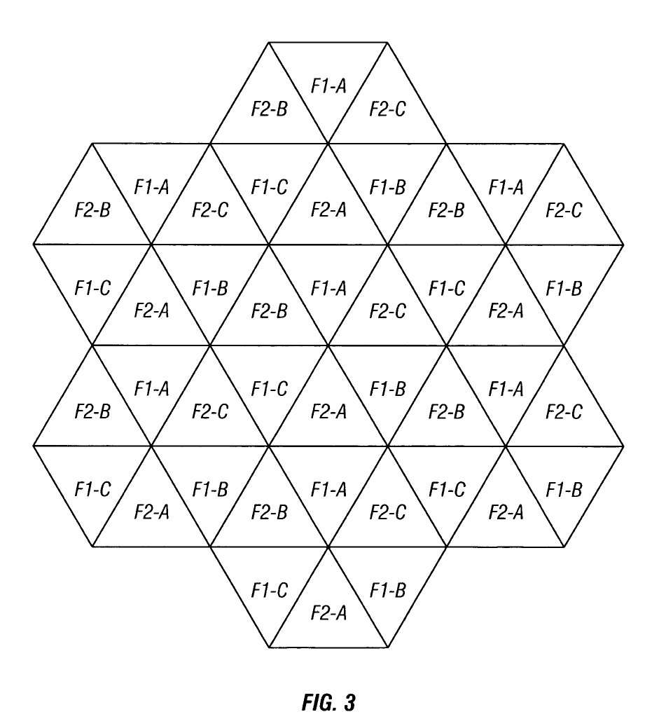

FIG. 2 is a block schematic diagram showing a network design for a base-station having six sectors 21-26 according to the invention. The base-station sectors use different frequency bands (F1 and F2) that are located in alternate sectors of the base-station. The labels A, B, C in FIG. 2 signify different sets of time-slots that in-sector links are active. A design goal for the network is to be able to deploy with only two available carriers and then grow the network, i.e. add more capacity and coverage, with additional carriers.

All communication with nodes in a sector that cannot communicate directly with the base-station is done through a first set of repeaters in the sector. Data packets from the base-station to a node are switched to the node through multiple hops. Similarly, data packets from a node are transmitted through multiple hops to the base-station. In the presently preferred embodiment of the invention, the number of hops in a sector is limited to four, i.e. Base-station→Repeater1→Repeater2→Repeater3→Terminal, to provide lower latency, although those skilled in the art will appreciate that another number of hops may be chosen, as desired, in connection with the invention.

The network topology is designed for urban and sub-urban deployments. In urban deployments the repeaters are preferably located at or below the median height of buildings in the sector to reduce the interference caused by the links.

Interference and reuse in the network is managed using frequency, time, and directionality.

There are two basic types of links:
1. Base-station (BS)→Level1-Repeaters (R(L1))
2. Repeater (R)→Repeater/Terminal (R/T) or Base-station→Terminal (T).

The BS→R(L1) links can be active in all sectors in all cells simultaneously because of transmitter (Tx) and receiver (Rx) antenna directionality. In the preferred embodiment, approximately 40% of all the time-slots are preferably reserved for these links. The ratio of down and up traffic can be set to, for example, 3:1, 2:1, 1:1 using an appropriate number of T/R time-slots at each end, although other ratios may be used in connection with the invention. This determines sector capacity, which in the preferred embodiment is approximately 6 Mbps for 5 MHz×2 and 8.4 Mbps for 7 MHz×2.

The in-sector R/BS→R/T links are active only in their assigned time-slots (A/B/C). The repeaters distribute data packets to/from terminals in these time-slots by scheduling non-interfering links to transmit at the same time. This enables the system to maximize the available capacity in the network and make up for the loss of capacity due to repeating.

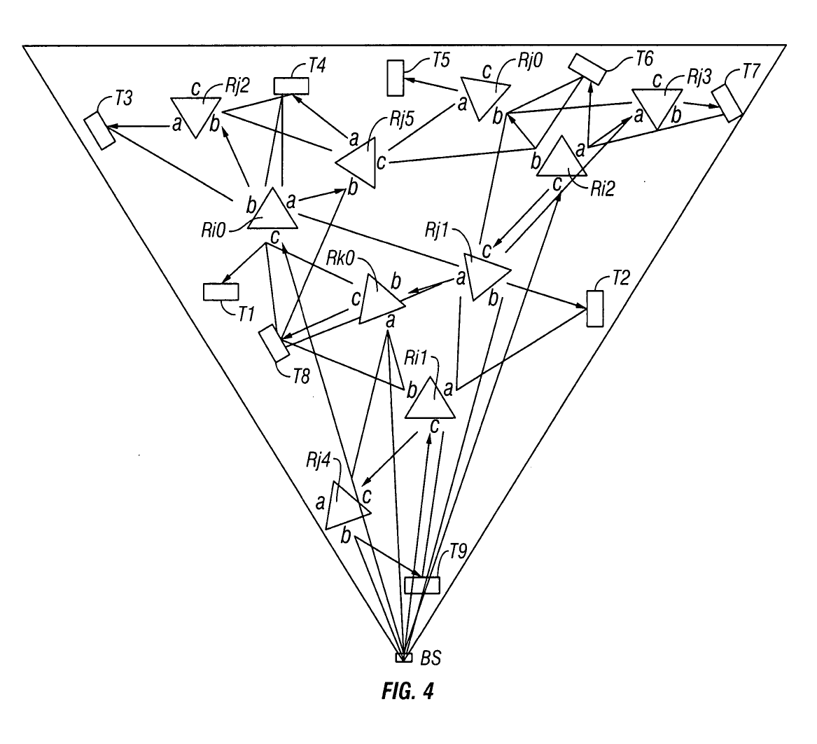

The deployment of several base-stations in an area is done by planning base-station sectors to manage interference. FIG. 3 is a block schematic diagram showing a network design in which system capacity is increased according to the invention.

Scalability

The capacity of a base-station can be increased by adding more carriers, for example a total of four or six carriers. This can be done sector by sector wherever more capacity is needed. This requires a different base-station radio for each sector for each carrier. It also requires another set of first level repeaters to communicate with the base-station on different carriers at the same time. Other nodes in each sector must switch to different carriers for the 20% in-sector time-slots (A/B/C). For example, a sector using carrier F1 in A time-slots, uses carrier F3 in B time-slots and carrier F5 in C time-slots. The additional capacity can be used to provide additional capacity to individual nodes or add more nodes in a sector.

Latency Management and Spectral Efficiency

Each sector in the network represents a tree structure rooted at the base-station. Links use two types of time-slots for communication—long and short.

Long time-slots are very spectrally efficient and can transmit a large number of bytes (˜2 k bytes) in each time-slot. A base-station communicates with level-1 repeaters (R1) using long time-slots because these links carry all the packets in the network destined to/from repeaters and terminals connected to them. Because 40% of all the time-slots are long, the overall network is very spectrally efficient.

Short time-slots have approximately 20% the capacity and 25% the duration of the long time-slots. All the Repeater→Repeater/Terminal and Base-station→Terminal links preferably use short time-slots. They are less spectrally efficient compared to the long time-slots, but they have lower latencies due to their shorter duration. This also improves the link utilization of the short time-slots because these links are likely to have fewer bytes to transmit compared to the Base-station→Level-1 Repeater links.

The short time-slots are time-multiplexed (A/B/C) to maximize the utilization of the spectrum and reduce latencies. Link scheduling takes into account interference information and schedules 3-4 simultaneous in-sector links in each short time-slot.

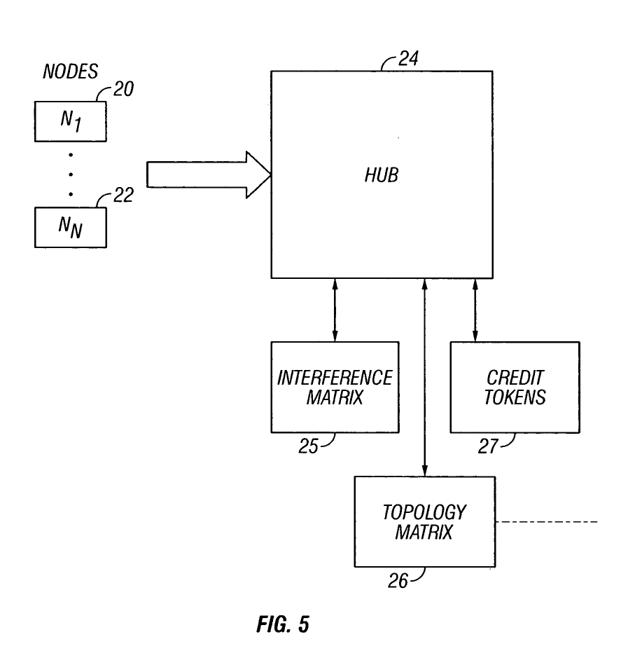

FIG. 4 is a block schematic diagram showing a typical sector having level-1, level-2, and level-3 repeaters (shown as triangles on FIG. 4, where level-1 repeaters are designated any of 0iR-2iR, level-2 repeaters are designated any of Rj0-Rj5, and level-2 repeaters are designated R.) and associated terminals (shown as rectangles on FIG. 4), and also showing a link tree (as shown by the lines that have arrows on FIG. 4) and potential interferers that must be taken into account for time-slot scheduling (as shown by the lines that do not have arrows on FIG. 4).

As described in U.S. patent application Ser. No. ______ unassigned (COWA0002) also owned by the Applicant, a network is defined as a set of links between nodes. For example, the uni-directional link between Node I and Node J is called Iᵢⱼ.

For example, there are N nodes and M directional links (Iᵢⱼ and Iⱼᵢ are considered different links) in a network. The interference between links in the network determines which links in the network can operate simultaneously. In other words, if a link Iᵢⱼ is active there exists a set of links Lᵢⱼ which cannot all be active at the same time. The set of all links Lᵢⱼ in the network constitute the interference matrix of the network. The degree of interference α(Iᵢⱼ, L) of a directional link Iᵢⱼ in a set L of links is defined as the number of links in set L that cannot be active due to interference while link Iᵢⱼ is active.

The bandwidth needed by links to carry actual traffic over a specific time period is a set of link bandwidth requests. The request may be zero. In that case, no traffic is to be carried over the link. Because link capacities vary depending on various link parameters, bandwidth requests are expressed in unit of credits, not bps (bits/sec). A credit is a unit the resource bandwidth allocation algorithm uses to maintain fair bandwidth distribution between links. It is the result of normalization of requested bandwidth, in terms of bps, with respect to the corresponding link capacity.

### EXAMPLE 1

FIG. 1 is a tree diagram that shows a network having eleven nodes and twenty directional links:
{I_{0,1}, I_{1,0}, I_{0,2}, I_{2,0}, I_{1,3}, I_{3,1}, I_{1,4}, I_{4,1}, I_{2,5}, I_{5,2}, I_{2,6}, I_{6,2}, I_{2,7}, I_{7,2}, I_{4,8}, I_{8,4}, I_{5,9}, I₉₅, I_{6,10}, I_{10,6}}

Suppose that the set of links L_{0,1} that gets interference, i.e. that cannot be active while link I_{0,1} is active, is:
L_{0,1}={I_{1,0}, I_{0,2}, I_{2,0}, I_{1,3}, I_{3,1}, I_{1,4}, I_{4,1}, I_{5,9}, I_{8,4}}

Similarly, suppose there are the following interference sets:
L_{1,0}={I_{0,1}, I_{0,2}, I_{2,0}, I_{1,3}, I_{3,1}, I_{1,4}, I_{4,1}, I_{9,5}, I_{4,8}}
L_{0,2}={I_{1,0}, I_{0,1}, I_{2,0}, I_{2,5}, I_{5,2}, I_{2,6}, I_{6,2}, I_{2,7}, I_{7,2}, I_{6,10}}
L_{2,0}={I_{1,0}, I_{0,1}, I_{0,2}, I_{2,5}, I_{5,2}, I_{2,6}, I_{6,2}, I_{2,7}, I_{7,2}, I_{10,6}}
L_{1,3}={I_{1,3}, I_{1,4}, I_{4,1}, I_{0,1}, I_{1,0}}
L_{3,1}={I_{1,3}, I_{1,4}, I_{4,1}, I_{0,1}, I_{1,0}}
L_{1,4}={I_{1,4}, I_{1,3}, I_{3,1}, I_{1,0}, I_{0,1}, I_{4,8}, I_{8,4}, I_{2,5}, I_{7,2}}
L_{4,1}={I_{1,4}, I_{1,3}, I_{3,1}, I_{1,0}, I_{0,1}, I_{4,8}, I_{8,4}, I_{5,2}, I_{2,7}}
L_{2,5}={I_{5,2}, I_{0,2}, I_{2,0}, I_{2,6}, I_{6,2}, I_{2,7}, I_{7,2}, I_{5,9}, I_{9,5}, I_{1,4}}
L_{5,2}={I_{2,5}, I_{0,2}, I_{2,0}, I_{2,6}, I_{6,2}, I_{2,7}, I_{7,2}, I_{5,9}, I_{9,5}, I_{4,1}}
L_{2,6}={I_{6,2}, I_{0,2}, I_{2,0}, I_{2,5}, I_{5,2}, I_{2,7}, I_{7,2}, I_{6,10}, I_{10,6}}
L_{6,2}={I_{2,6}, I_{0,2}, I_{2,0}, I_{2,5}, I_{5,2}, I_{2,7}, I_{7,2}, I_{6,10}, I_{10,6}}
L_{2,7}={I_{7,2}, I_{0,2}, I_{2,0}, I_{2,5}, I_{5,2}, I_{2,6}, I_{6,2}, I_{4,1}}
L_{7,2}={I_{2,7}, I_{0,2}, I_{2,0}, I_{2,5}, I_{5,2}, I_{2,6}, I_{6,2}, I_{1,4}}
L_{4,8}={I_{8,4}, I_{1,4}, I_{4,1}, I_{1,0}}
L_{8,4}={I_{4,8}, I_{1,4}, I_{4,1}, I_{0,1}}
L_{5,9}={I_{9,5}, I_{2,5}, I_{5,2}, I_{0,1}}
L_{9,5}={I_{5,9}, I_{2,5}, I_{5,2}, I_{1,0}}
L_{6,10}={I_{10,6}, I_{2,6}, I_{6,2}, I_{0,2}}
L_{10,6}={I_{6,10}, I_{2,6}, I_{6,2}, I_{2,0}}.

Equivalently, the interference can be expressed using the interference matrix I shown in Table 1 below.

TABLE 1
Interference Matrix I

| | I_{0,1} | I_{1,0} | I_{0,2} | I_{2,0} | I_{1,3} | I_{3,1} | I_{1,4} | I_{4,1} | I_{2,5} | I_{5,2} | I_{2,6} | I_{6,2} | I_{2,7} | I_{7,2} | I_{4,8} | I_{8,4} | I_{5,9} | I_{9,5} | I_{6,10} | I_{10,6} |
|---|---|---|---|---|---|---|---|---|---|---|---|---|---|---|---|---|---|---|---|---|
| I_{0,1} | | 1 | 1 | 1 | 1 | 1 | 1 | 1 | | | | | | | | 1 | 1 | | | |
| I_{1,0} | 1 | | 1 | 1 | 1 | 1 | 1 | 1 | | | | | | | 1 | | | 1 | | |
| I_{0,2} | 1 | 1 | | 1 | | | | | 1 | 1 | 1 | 1 | 1 | 1 | | | | | 1 | |
| I_{2,0} | 1 | 1 | 1 | | | | | | 1 | 1 | 1 | 1 | 1 | 1 | | | | | | 1 |
| I_{1,3} | 1 | 1 | | | | 1 | 1 | 1 | | | | | | | | | | | | |
| I_{3,1} | 1 | 1 | | | 1 | | 1 | 1 | | | | | | | | | | | | |
| I_{1,4} | 1 | 1 | | | 1 | 1 | | 1 | 1 | | | | | 1 | 1 | 1 | | | | |
| I_{4,1} | 1 | 1 | | | 1 | 1 | 1 | | | 1 | | | 1 | | 1 | 1 | | | | |
| I_{2,5} | | | 1 | 1 | | | 1 | | | 1 | 1 | 1 | 1 | 1 | | | 1 | 1 | | |
| I_{5,2} | | | 1 | 1 | | | | 1 | 1 | | 1 | 1 | 1 | 1 | | | 1 | 1 | | |
| I_{2,6} | | | 1 | 1 | | | | | 1 | 1 | | 1 | 1 | 1 | | | | | 1 | 1 |
| I_{6,2} | | | 1 | 1 | | | | | 1 | 1 | 1 | | 1 | 1 | | | | | 1 | 1 |
| I_{2,7} | | | 1 | 1 | | | | 1 | 1 | 1 | 1 | 1 | | 1 | | | | | | |
| I_{7,2} | | | 1 | 1 | | | 1 | | 1 | 1 | 1 | 1 | 1 | | | | | | | |
| I_{4,8} | | 1 | | | | | 1 | 1 | | | | | | | | 1 | | | | |
| I_{8,4} | 1 | | | | | | 1 | 1 | | | | | | | 1 | | | | | |
| I_{5,9} | 1 | | | | | | | | 1 | 1 | | | | | | | | 1 | | |
| I_{9,5} | | 1 | | | | | | | 1 | 1 | | | | | | | 1 | | | |
| I_{6,10} | | | 1 | | | | | | | | 1 | 1 | | | | | | | | 1 |
| I_{10,6} | | | | 1 | | | | | | | 1 | 1 | | | | | | | 1 | |

Number 1 in the matrix of Table 1 shows that links in a corresponding row and column cannot be active at the same time. Empty boxes in the matrix represent 0s.

A link bandwidth request is expressed in terms of the link capacity. Suppose that 64 credits are equivalent to full link capacity. If a link is given 64 credits, that link can be active all the time. If a link is given 32 credits, that link is active 50% of the time.

Suppose at a particular time, there exist the following bandwidth requests in credits:
R_{0,2}=35
R_{2,5}=20
R_{2,6}=15
R_{5,9}=10
R_{6,10}=10
R_{3,1}=10
R_{1,0}=10
R_{0,1}=5.

The set of links requesting bandwidth is:
L={I_{0,2}, I_{2,5}, I_{2,6}, I_{5,9} I_{6,10}, I_{3,1}, I_{1,0}, I_{0,1}}

Using the interference matrix I, the degree of interference of I_{0,2} in this set is computed as follows:
α(I_{0,2}, L)=I[I_{0,2}][I_{2,5}]+I[I_{0,2}][I_{2,6}]+I[I_{0,2}][I_{5,9}]+I[I_{0,2}][I_{6,10}]+I[I_{0,2}][I_{3,1}]+I[I_{0,2}][I_{1,0}]+I[I_{0,2}][I_{0,1}]=5

Other degrees of interference can be computed similarly:
α(I_{2,5}, L)=I[I_{2,5}][I_{0,2}]+I[I_{2,5}][I_{2,6}]+I[I_{2,5}][I_{5,9}]+I[I_{2,5}][I_{6,10}]+I[I_{2,5}][I_{3,1}]+I[I_{2,5}][I_{1,0}]+I[_{2,5}][I_{0,1}]=3
α(I_{2,6}, L)=I[I_{2,6}][I_{0,2}]+I[I_{2,6}][I_{2,5}]+I[I_{2,6}][I_{5,9}]+I[I_{2,6}][I_{6,10}]+I[I_{2,6}][I_{3,1}]+I[I_{2,6}][I_{1,0}]+I[I_{2,6}][I_{0,1}]=3
α(I_{5,9}, L)=I[I_{5,9}][I_{0,2}]+I[I_{5,9}][I_{2,5}]+I[I_{5,9}][I_{2,6}]+I[I_{5,9}][I_{6,10}]+I[I_{5,9}][I_{3,1}]+I[I_{5,9}][I_{1,0}]+I[I_{5,9}][I_{0,1}]=2
α(I_{6,10}, L)=I[I_{6,10}][I_{0,2}]+I[I_{6,10}][I_{2,5}]+I[I_{6,10}][I_{2,6}]+I[I_{6,10}][I_{5,9}]+I[I_{6,10}][I_{3,1}]+I[I_{6,10}][I_{1,0}]+I[I_{6,10}][I_{0,1}]=2
α(I_{3,1}, L)=I[I_{3,1}][I_{0,2}]+I[I_{3,1}][I_{2,5}]+I[I_{3,1}][I_{2,6}]+I[I_{3,1}][I_{5,9}]+I[I_{3,1}][I_{6,10}]+I[I_{3,1}][I_{1,0}]+I[I_{3,1}][I_{0,1}]=1
α(I_{1,0}, L)=I[I_{1,0}][I_{0,2}]+I[I_{1,0}][I_{2,5}]+I[I_{1,0}][I_{2,6}]+I[I_{1,0}][I_{5,9}]+I[I_{1,0}][I_{6,10}]+I[I_{1,0}][I_{3,1}]+I[I_{1,0}][I_{0,1}]=3
α(I_{0,1}, L)=I[I_{0,1}][I_{0,2}]+I[I_{0,1}][I_{2,5}]+I[I_{0,1}][I_{2,6}]+I[I_{0,1}][I_{5,9}]+I[I_{0,1}][I_{6,10}]+I[I_{0,1}][I_{3,1}]+I[I_{0,1}][I_{1,0}]=4.
   Problem Formulation

Assume that time division multiple access (TDMA) techniques are used to multiplex link activities. Given the constraints of the interference matrix and a list of bandwidth requests, attempt to find a schedule to make optimal use of total network capacity and fairly satisfy bandwidth requests.

An equivalent problem is to find an optimal schedule that satisfies all requests using the least amount of network resources, in this case, credits or time. If the average activity concurrency is defined as the average number of concurrent active links of a schedule, then the optimal schedule is the one having the highest average activity concurrency.

A schedule specifies when a set of links are active and also specifies the members of the set. Mathematically, a schedule S can be expressed as:
S={(Lᵢ, Gᵢ)|Gᵢ is the credits assigned to set of links Lᵢ,
Lᵢ is the set of links that can be all active at the same time without interfering with each other}.

### EXAMPLE 2

Continuing with Example 1 above, the following is one possible schedule for links requesting bandwidth:
S={({I_{5,9}, I_{6,10}, I_{3,1}}, 10), ({I_{0,2}}, 35), ({I_{2,6}, I_{0,1}}, 5), ({I_{2,6}, I_{1,0}}, 10), ({I_{2,5}}, 20)}

This schedule uses 10+35+5+10+20=80 credits to satisfy 35+20+15+10+10+10+10+5=115 requested credits. The average activity concurrency is 115/80=1.4375.

This schedule is not necessarily the best schedule for this example. In fact, using the algorithm described in detail below, one can find a better schedule using less credits while still satisfying all bandwidth requests.

An optimal schedule must satisfy the following conditions:

For any link, granted credits equals requested credits
Σ_{ljk⊂Li} Gᵢ=Rⱼₖ

Minimal total network resource spent
(ΣGᵢ)<=(ΣG′ᵢ) for ∀S′={(L′ᵢ, G′ᵢ)}

Because this problem is NP-hard, a heuristic algorithm is disclosed herein for a near optimal solution. For purposes of the discussion herein, a problem is NP-hard if an algorithm for solving it can be translated into one for solving any other NP-problem, i.e. nondeterministic polynomial time problem. NP-hard therefore means “at least as hard as any NP-problem,” although it might, in fact, be harder.

Simulations show that in many cases this algorithm generates optimal schedules; and in cases that it does not, the schedules are usually close to optimal and are always better than average.

Bandwidth Allocation Algorithm

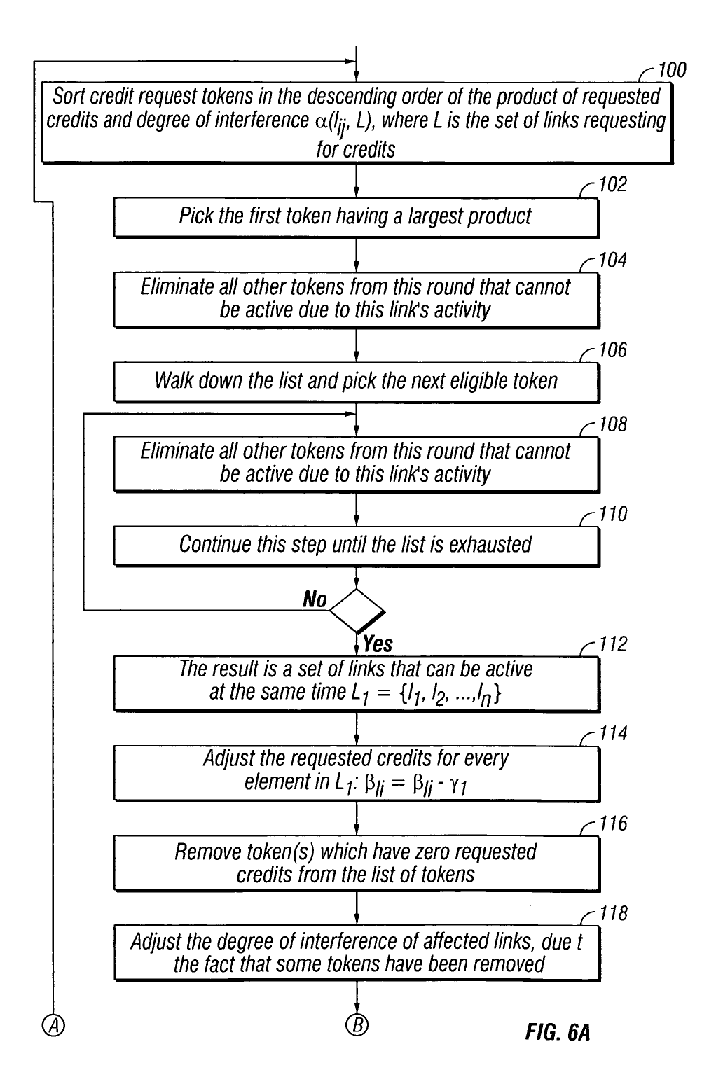

The algorithm disclosed herein is based on the assumption that there exists a centralized node (hub) in the network that coordinates all network activities (see FIG. 5). The hub 54 keeps the following data structures to represent its knowledge of the network:
Interference matrix 55 (defined above). It is important to note that interference matrix is symmetrical.
Topology matrix 56: defines valid links that can transmit/receive data. This is a proper subset of the interference matrix.
A list of credit request tokens 57. Each token represents a directional link that needs bandwidth.

Assume that each node 50, 52 in the network conveys its knowledge of interference, topology, and its bandwidth needs to the hub. The actual mechanism for transporting this information to the hub is within the knowledge of those skilled in the art and is, therefore, not discussed in detail herein. The hub collects this information from individual nodes and constructs the interference matrix, topology matrix, and list of credit tokens to have a complete view of the network.

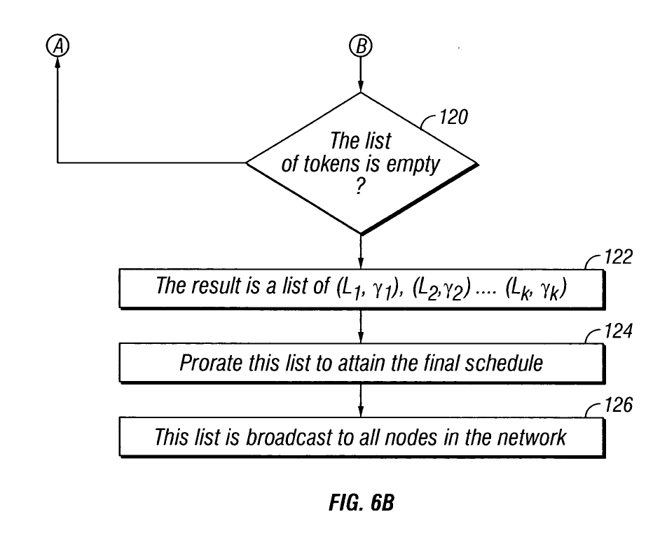

The bandwidth allocation algorithm running at hub is described as followed (see FIG. 6):
1. Sort credit request tokens in the descending order of the product of requested credits and degree of interference α(Iᵢⱼ, L), where L is the set of links requesting for credits (100).
2. Pick the first token having a largest product (102). This is the first candidate of the set of links to be allocated credit for this round. Eliminate all other tokens from this round that cannot be active due to this link's activity (104).
3. Walk down the list and pick the next eligible token (106). This is the second candidate of the set of links to be allocated credits for this round. Eliminate all other tokens from this round that cannot be active due to this link's activity (108). Continue this step until the list is exhausted (110).
4. The result is a set of links that can be active at the same time L₁={I₁, I₂, . . . Iₙ} (112). Let βₗᵢ be requested credits of link Iᵢ. The amount of credits allocated to each element of set L₁ is γ₁=min{βₗ₁, βₗ₂, . . . , βₗₙ} Adjust the requested credits for every element in L₁: βₗᵢ=βₗᵢ−γ₁ (114). Remove token(s) which have zero requested credits from the list of tokens (116).
5. Adjust the degree of interference of affected links, due to the fact that some tokens have been removed (118).
6. Repeat steps 1-5 until the list of tokens is empty (120).
7. The result is a list of (L₁, γ₁), (L₂, γ₂) . . . (Lₖ, γₖ) (122). Now, prorate this list to attain the final schedule (124). Let S be the total resource of the network in terms of credit; and let χᵢ=γᵢ*S//Σ^{0,k}γⱼ. The list (L₁, χ₁), (L₂, χ₂) . . . (Lₖ, χₖ) represents how the links are organized into sets of concurrent active links and how much resource each set of links are supposed to get. This list is broadcast to all nodes in the network (126).

### EXAMPLE 3

Use this algorithm to compute the schedule for Example 2.

Step 1 (see Table 2 below).

TABLE 2
Step 1

| | Degree of interference | | |
|---|---|---|---|
| Link | α(Iᵢⱼ, L) | Requested credit Rᵢⱼ | α(Iᵢⱼ, L) * Rᵢⱼ |
| I_{0,2} | 5 | 35 | 175 |
| I_{2,5} | 3 | 20 | 60 |
| I_{2,6} | 3 | 15 | 45 |
| I_{1,0} | 3 | 10 | 30 |
| I_{5,9} | 2 | 10 | 20 |
| I_{6,10} | 2 | 10 | 20 |
| I_{3,1} | 2 | 10 | 20 |
| I_{0,1} | 4 | 5 | 20 |

Steps 2-5:

Get the first Schedule S={({I_{0,2}, I_{5,9}, I_{3,1}}, 10)}.

Go back to step 1 (see Table 3 below).

TABLE 3
Go Back to Step 1

| | Degree of interference | | |
|---|---|---|---|
| Link | α(Iᵢⱼ, L) | Requested credit Rᵢⱼ | α(Iᵢⱼ, L) * Rᵢⱼ |
| I_{0,2} | 5 | 25 | 125 |
| I_{2,5} | 2 | 20 | 40 |
| I_{2,6} | 2 | 15 | 30 |
| I_{1,0} | 2 | 10 | 20 |
| I_{6,10} | 2 | 10 | 20 |
| I_{0,1} | 2 | 5 | 10 |

Steps 2-5:

Get a revised Schedule S={({I_{0,2}, I_{5,9}, I_{3,1}}, 10), ({I_{0,2}}, 25)}.

Go back to step 1 (see Table 4 below).

TABLE 4
Go Back to Step 1

| | Degree of interference | | |
|---|---|---|---|
| Link | α(Iᵢⱼ, L) | Requested credit Rᵢⱼ | α(Iᵢⱼ, L) * Rᵢⱼ |
| I_{2,5} | 1 | 20 | 20 |
| I_{2,6} | 1 | 15 | 15 |
| I_{1,0} | 1 | 10 | 10 |
| I_{6,10} | 1 | 10 | 10 |
| I_{0,1} | 1 | 5 | 5 |

Steps 2-5:

Get a revised Schedule:
S={({I_{0,2}, I_{5,9}, I_{3,1}}, 10), ({I_{0,2}}, 25), ({I_{2,5}, I_{1,0}, I_{6,0}}, 10)}.

Go back to step 1 (see Table 5 below).

TABLE 5
Go Back to Step 1

| | Degree of interference | | |
|---|---|---|---|
| Link | α(Iᵢⱼ, L) | Requested credit Rᵢⱼ | α(Iᵢⱼ, L) * Rᵢⱼ |
| I_{2,6} | 1 | 15 | 15 |
| I_{2,5} | 1 | 10 | 10 |
| I_{0,1} | 0 | 5 | 0 |

Steps 2-5:

Get a revised Schedule:
S={({I_{0,2}, I_{5,9}, I_{3,1}}, 10), ({I_{0,2}}, 25), ({I_{2,5}, I_{1,0}, I_{6,0}}, 10) ({I_{2,6}, I_{0,1}} 5)}

Go back to step 1 (see Table 6 below)

TABLE 6
Go Back to Step 1

| | Degree of interference | | |
|---|---|---|---|
| Link | α(Iᵢⱼ, L) | Requested credit Rᵢⱼ | α(Iᵢⱼ, L) * Rᵢⱼ |
| I_{2,6} | 1 | 10 | 10 |
| I_{2,5} | 1 | 10 | 10 |

Steps 2-5:

Get a revised Schedule:
S={({I_{0,2}, I_{5,9}, I_{3,1}}, 10), ({I_{0,2}}, 25), ({I_{2,5}, I_{1,0}, I_{6,0}}, 10), ({I_{2,6}, I_{1,0}}, 5), ({I_{2,6}}, 10)}.

Go back to step 1 (see Table 7 below).

TABLE 7
Go Back to Step 1

| | Degree of interference | | |
|---|---|---|---|
| Link | α(Iᵢⱼ, L) | Requested credit Rᵢⱼ | α(Iᵢⱼ, L) * Rᵢⱼ |
| I_{2,5} | 1 | 10 | 10 |

Steps 2-5:

Get the schedule:
S={({I_{0,2}, I_{5,9}, I_{3,1}}, 10), ({I_{0,2}}, 25), ({I_{2,5}, I_{1,0}, I_{6,0}}, 10), ({I_{2,6}, I_{0,1}}, 5), ({I_{2,6}}, 10), ({I_{2,5}}, 10)}.

This schedule uses 10+25+10+5+10+10=70 credits to satisfy 35+20+15+10+10+10+10+5=115 requested credits. The average activity concurrency is 115/70=1.6428. Obviously, this schedule is better than the one presented in the previous example. In fact, it can be proved that this schedule is the optimal one for this particular example. There is no other schedule that can use less number of credits to satisfy all these bandwidth requests.

Step 7:

Because the total resource is only 64 credits, the previous schedule is prorated to obtain the final schedule:
S_{f}={({I_{0,2}, I_{5,9}, I_{3,1}}, 9), ({I_{0,2}}, 23), ({I_{2,5}, I_{1,0}, I_{6,0}}, 9), ({I_{2,6}, I_{0,1}}, 5), ({I_{2,6}}, 9), ({I_{2,5}}, 9)}.

This schedule is broadcast to all nodes in the network.

Upon receiving the schedule, each node in the network uses the binary allocation map scheme to compute its own slot assignment. Allocation map is an array of numbers that is used to map a range of consecutive numbers to partially equally spaced numbers. The idea is that, given a portion of resources, a node can figure out its active timeslots by projecting that portion (consecutive numbers) through the map. For example, all links in set Lᵢ are assigned to the range [Σ^{0,i-1}χⱼ, Σ^{0,i}χⱼ], which, in turn, represent a set of near-equally spaced time slots.

### EXAMPLE 4

Assume that the allocation map is designed for 64 time slots, corresponding to 64 credits.

The allocation map for 64 time slots is shown in Table 8 below.

TABLE 8
Allocation Map, 64 Time Slots

| | tslot | | | | | | | | | | | | | | | |
|---|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 | 16 |
| index | 1 | 33 | 17 | 49 | 9 | 41 | 25 | 57 | 5 | 37 | 21 | 53 | 13 | 45 | 29 | 61 |
| | tslot | | | | | | | | | | | | | | | |
| | 17 | 18 | 19 | 20 | 21 | 22 | 23 | 24 | 25 | 26 | 27 | 28 | 29 | 30 | 31 | 32 |
| index | 3 | 35 | 19 | 51 | 11 | 43 | 27 | 59 | 7 | 39 | 23 | 55 | 15 | 47 | 31 | 63 |
| | tslot | | | | | | | | | | | | | | | |
| | 33 | 34 | 35 | 36 | 37 | 38 | 39 | 40 | 41 | 42 | 43 | 44 | 45 | 46 | 47 | 48 |
| index | 2 | 34 | 18 | 50 | 10 | 42 | 26 | 58 | 6 | 38 | 22 | 54 | 14 | 46 | 30 | 62 |
| | tslot | | | | | | | | | | | | | | | |
| | 49 | 50 | 51 | 52 | 53 | 54 | 55 | 56 | 57 | 58 | 59 | 60 | 61 | 62 | 63 | 64 |
| index | 4 | 36 | 20 | 52 | 12 | 44 | 28 | 60 | 8 | 40 | 24 | 56 | 16 | 48 | 32 | 64 |

A range of credit indices can be deduced for each set of links in the final schedule S_{f}. For example, the set {I_{0,2}, I_{5,9}, I_{3,1}} is correspondent to [1,9]. Set {I_{0,2}} is correspondent to [10,32]; and so on.
S_{f}={({I_{0,2}, I_{5,9}, I_{3,1}}, 9), ({I_{0,2}}, 23), ({I_{2,5}, I_{1,0}, I_{6,0}}, 9), ({I_{2,6}, I_{0,1}}, 5), ({I_{2,6}}, 9), ({I_{2,5}}, 9)}

Using the combination of allocation map and the final schedule S_{f}, any node is aware of which link is active at a particular time slot t. For example, the set {I_{0,2}, I_{5,9}, I_{3,1}} is active in time slots 1, 5, 9, 17, 25, 33, 41, 49, 57.

Maximizing Network Capacity Using Unscheduled Time Slots

To facilitate the explanation of using unscheduled time slots, use the schedule obtained in previous example.
S={({I_{0,2}, I_{5,9}, I_{3,1}}, 10), ({I_{0,2}}, 25), ({I_{2,5}, I_{1,0}, I_{6,0}}, 10), ({I_{2,6}, I_{0,1}} 5), ({I_{2,6}}, 10), ({I_{2,5}}, 10)}

Some notable points need to be made about this schedule:
1. The number of links in each set tends to be highest at the beginning of the schedule and tends to taper off toward the end of the schedule.
2. Even with the set causing most interference in the network, there are some links that can be active at the same time without causing interference to the links in the set.
3. The interference caused by sets at the beginning of the schedule tend to be the highest; and that interference tends to taper off going toward the end of the schedule.

With these observations, it can be seen the scheduled bandwidth very likely represents only about half of total network capacity. Hence, a collision-based mechanism is devised to use the other half, which is going to be wasted if not used otherwise.

Each node in the network maintains, for each of its local links, one set of links interfering with that link. Local links are links directly connected to the node. By using the schedule S broadcast by the Hub, a node knows which of its local links can be active without interfering with the scheduled links which are currently active. An active unscheduled link at time slot t is a link that is not scheduled to be active at time t, but could be made active if the intended receiver is ready to receive. This can be decided by its directly connected nodes because this activity does not cause interference with the current active scheduled links. A link can be unscheduled at one time slot and is scheduled in another time slot. Active unscheduled links can interfere and collide which each other, but they do not interfere with the currently active scheduled links.

Unscheduled links are mainly used when a node does not have uplink scheduled bandwidth and need to request bandwidth or need to send some small uplink transient traffic. It is used to boost up network capacity, as well as network response time.

### EXAMPLE 5

Using Example 4, the final schedule is:
S={({I_{0,2}, I_{5,9}, I_{3,1}}, 10), ({I_{0,2}}, 25), ({I_{2,5}, I_{1,0}, I_{6,0}}, 10), ({I_{2,6}, I_{0,1}}, 5), ({I_{2,6}}, 10), ({I_{2,5}}, 10)}

Pick one time slot t. Suppose that it corresponds to ({I_{2,6}, I_{0,1}}, 5) in the schedule. This means that I_{2,6} and I_{0,1} are active at time slot t. The matrix of interference indicates that any of links {I_{4,8}, I_{9,5}} can also be active. Although each node does not maintain the matrix of interference for the whole network, it does keep sets of interference links for each of its local link. Hence, local nodes (4 and 9) know that they can activate the link at time slot t. In this specific example, if both I_{4,8} I_{9,5} are active, they still do not collide. However, that is not always the case. Nodes can use a backoff mechanism to resolve collision if it happens.

Although the invention is described herein with reference to the preferred embodiment, one skilled in the art will readily appreciate that other applications may be substituted for those set forth herein without departing from the spirit and scope of the present invention. Accordingly, the invention should only be limited by the claims included below.

1. A mesh access network, comprising:
at least one base-station comprising a plurality of sectors;
each sector comprising of a plurality of terminal nodes, said terminal nodes comprising both indoor terminal nodes and outdoor terminal nodes, and comprising a plurality of outdoor repeaters;
wherein said nodes in each sector are arranged in a tree structure starting from said base-station;
wherein said base-station sectors use different frequency bands that are located in alternate sectors of said base-station; and
a module for interference management and sector reuse comprising network management of frequency, time, and directionality.

2. The network of claim 1, comprising:
at least one Base-Station→Level1-repeaters link; and
at least one Repeater→Repeater/Terminal or Base-station→Terminal link.

3. The network of claim 2, wherein said Base-Station→Level1-repeaters link can be active in all sectors in all cells simultaneously due to of transmitter and receiver antenna directionality;
wherein a predetermined percentage of all time-slots are preferably reserved for Base-Station→Level1-repeaters links.

4. The network of claim 2, wherein said in-sector Repeater→Repeater/Terminal or Base-station→Terminal link is active only in an assigned time-slot;
wherein said repeaters distribute data packets to/from terminals in said time-slots by scheduling non-interfering links to transmit at a same time.

5. The network of claim 1, wherein a sector of each base-station having a first frequency band is at least a cell radius away from another sector having said first frequency band.

6. The network of claim 1, wherein sectors with a same carrier and time-slot assignment are located a cell radius away from each other.

7. The network of claim 1, wherein communication with nodes in a sector that cannot communicate directly with said base-station is done through a first set of repeaters in a sector;
wherein data packets from said base-station to a node are switched to said node through multiple hops; and
wherein data packets from a node are transmitted through multiple hops to said base-station.

8. The network of claim 1, wherein capacity of a base-station is increased by adding more carriers.

9. The network of claim 7, wherein carriers are added sector by sector;
wherein a different base-station radio is provided for each sector for each carrier.

10. The network of claim 9, wherein at least a second set of first level repeaters is provided to communicate with said base-station on different carriers at the same time.

11. The network of claim 9, wherein other nodes in each sector must switch to different carriers for in-sector time-slots.

12. The network of claim 1, wherein each sector in said network represents a tree structure rooted at said base-station.

13. The network of claim 1, further comprising:
a plurality of links that use any of two types of time-slots for communication, wherein said time slots comprise long time slots and short time slots.

14. The network of claim 13, wherein long time-slots are spectrally efficient and are adapted to transmit a large number of bytes in each time-slot.

15. The network of claim 14, wherein said base-station communicates with level-1 repeaters (R1) using long time-slots, wherein said time-slots carry substantially all packets in said network destined to/from repeaters and terminals connected thereto.

16. The network of claim 13, wherein short time-slots have about 20% the capacity and 25% the duration of the long time-slots.

17. The network of claim 16, wherein substantially all Repeater→Repeater/Terminal and Base-station→Terminal links use short time-slots.

18. The network of claim 16, wherein short time-slots are time-multiplexed to maximize utilization of spectrum and reduce latency.
